(19) United States
(12) Patent Application Publication
(10) Pub. No.: US 2024/0227787 A9
(43) Pub. Date: Jul. 11, 2024

(54) VEHICLE SYSTEM

(71) Applicant: Yazaki Corporation, Tokyo (JP)

(72) Inventors: Nobuhiro SUGIYAMA, Shizuoka (JP); You Yanagida, Shizuoka (JP); Naomi Kisu, Shizuoka (JP); Katsumi Sato, Shizuoka (JP); Hiromu Ike, Shizuoka (JP)

(73) Assignee: Yazaki Corporation, Tokyo (JP)

(21) Appl. No.: 18/402,029

(22) Filed: Jan. 2, 2024

Related U.S. Application Data
(63) Continuation of application No. PCT/JP22/26455, filed on Jul. 1, 2022.

(30) Foreign Application Priority Data
Aug. 4, 2021 (JP) 2021-127905

(51) Int. Cl. B60W 30/08; B60R 16/023

(52) U.S. Cl. CPC B60W 30/08; B60R 16/023; B60W 2756/10

(57) ABSTRACT

A vehicle system includes a plurality of devices and a controller. The plurality of devices are mounted on the vehicle, and each of the devices implements a function having a safety standard of a predetermined level set therein. The controller is capable of executing processing related to the safety standard on the devices, and includes a plurality of ECUs respectively allocated for the levels of the safety standards. The plurality of ECUs are respectively connected to the devices in which the safety standards of the allocated levels are set without being connected to the devices in which the safety standards of different levels are set, and execute, on the connected devices, processing related to the safety standards according to the allocated levels. Accordingly, the vehicle system can appropriately construct a system that secures safety.

### CROSS-REFERENCE TO RELATED APPLICATION(S)

This application is a continuation application of International Application No. PCT/JP2022/026455 filed on Jul. 1, 2022 which claims the benefit of priority from Japanese Patent Application No. 2021-127905 filed on Aug. 4, 2021 and designating the U.S., the entire contents of which are incorporated herein by reference.

### BACKGROUND OF THE INVENTION

### 1. Field of the Invention

The present invention relates to a vehicle system.

### 2. Description of the Related Art

Conventionally, as a vehicle system, for example, Japanese Patent Application Laid-open No. 2015-99517 describes a vehicle control device that controls a vehicle using a plurality of pieces of software in which different degrees of safety are set. This vehicle control device includes, for example, a plurality of pieces of software respectively having different degrees of safety set therein, a storage area corresponding to the degree of safety, the storage area being divided into a plurality of areas corresponding to the degrees of safety of the plurality of pieces of software and configured to store data calculated by the software, a shared storage area configured to store, for access of the software having a low degree of safety, the data calculated by the software having a high degree of safety, and a switching unit configured to switch, according to the degree of safety of the software, the storage area of an access destination at the time of referring to the same data, in which the plurality of pieces of software include a function that calls the switching unit to refer to the same data. According to this configuration, the vehicle control device can call, when the storage area accessed by the software is changed, the switching unit by the function of the software and refer to the same data without using hardware such as a memory management unit, thereby making it possible to improve reusability of the software.

Meanwhile, in the vehicle control device described in Japanese Patent Application No. 2021-127905, for example, since a plurality of pieces of software having different degrees of safety are mixed in the same vehicle control device, it is necessary to match the performance of a device with software having a high degree of safety, and as a result, there is a possibility that excessive performance is caused when software having a low degree of safety is executed.

### SUMMARY OF THE INVENTION

Therefore, the present invention has been made in view of the above-described problems, and it is an object of the present invention to provide a vehicle system capable of appropriately constructing a system for securing safety.

In order to achieve the above mentioned object, a vehicle system according to one aspect of the present invention includes a plurality of devices mounted on a vehicle, each of the devices implementing a function having a safety standard of a predetermined level set therein; and a controller configured to execute, on the devices, processing related to the safety standard, wherein the controller includes a plurality of single-level controllers, each of the single-level controllers being allocated for a corresponding one of the levels of the safety standards, and wherein each of the single-level controllers is connected to a corresponding one of the devices configured to respectively implement the functions in which the safety standards of the allocated levels are set without being connected to the device configured to implement the function in which the safety standard of a different level is set, and executes, on the corresponding device connected thereto, processing related to the safety standard according to the allocated level without processing related to the safety standard of a plurality of levels.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of a vehicle system according to an embodiment;

FIG. 2 is a block diagram illustrating the configuration example of the vehicle system according to the embodiment;

FIG. 3 is a diagram illustrating a relationship between a function of a vehicle and a vehicle safety standard according to the embodiment;

FIG. 4 is a diagram illustrating a configuration example of software of ASIL-A according to the embodiment;

FIG. 5 is a diagram illustrating a configuration example of software of ASIL-B according to the embodiment;

FIG. 6 is a diagram illustrating a configuration example of software of ASIL-C according to the embodiment;

FIG. 7 is a diagram illustrating a configuration example of software of ASIL-D according to the embodiment;

FIG. 8 is a flowchart illustrating an operation example of the vehicle system; and

FIG. 9 is a block diagram illustrating a configuration example of a vehicle system according to a modification.

### DETAILED DESCRIPTION OF THE PREFERRED EMBODIMENTS

A mode (embodiment) for carrying out the present invention will be described in detail with reference to the drawings. The present invention is not limited by contents described in the following embodiments. In addition, the component elements described below include those that can be easily assumed by those skilled in the art and those that are substantially the same. Furthermore, configurations described below can be appropriately combined. In addition, various omissions, substitutions, or changes in the configuration can be made without departing from the gist of the present invention.

### Embodiment

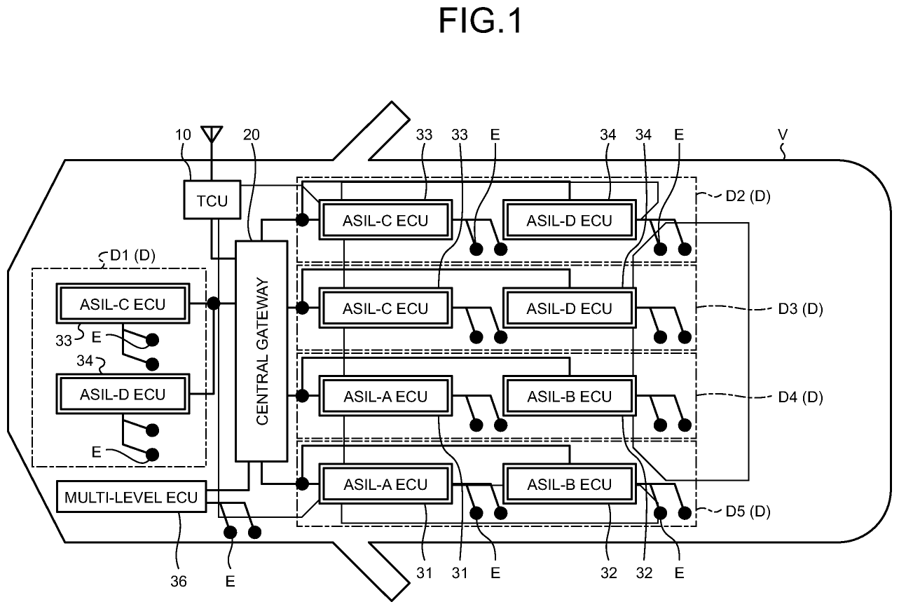

A vehicle system 1 according to an embodiment will be described with reference to the drawings. The vehicle system 1 is provided in a vehicle V, and controls a plurality of devices E mounted on the vehicle V by controllers (respective ECUs 31 to 36 to be described later). Here, as illustrated in FIG. 1, the devices E mounted on the vehicle V and the controllers are divided into a plurality of control systems D (D1 to D5) according to a domain. Here, the domain represents a system that controls the vehicle V, and is, for example, information arbitrarily allocated for each function of the vehicle V in order to distinguish the control systems. The control system D1 represents a powertrain system (power train system) representing devices for efficiently transmitting rotational energy generated by an engine (motor) to a drive wheel. The control system D2 represents an advanced driver-assistance systems (ADAS) or an automatic driving system. Here, the ADAS grasps a situation around the vehicle V using various sensors and assists a driver's driving operation. The control system D3 represents a chassis system including a suspension, a steering, and the like. The control system D4 represents a human machine interface (HMI)/multimedia (MM) system. Here, the HMI provides necessary information to a user such as a driver. MM represents a multimedia system such as entertainment. The control system D5 represents a body system including a headlight, a backlight, and the like.

Each of the plurality of devices E is provided in a corresponding one of the control systems D1 to D5, and each of the plurality of devices E implements a function in which a safety standard (an automobile safety level) of a predetermined level, that is, an automotive safety integrity level (ASIL) is set. That is, ASIL is set for each function of the vehicle V, and the plurality of devices E implement the function having ASIL set therein. Here, ASIL represents a safety standard of the vehicle V defined in the ISO 26262 standard, and includes four stages of ASIL-A to ASIL-D according to the level of a safety standard. In ASIL, a level of a safety standard becomes higher from ASIL-A toward ASIL-D. That is, ASIL-D has the highest level of the safety standard, ASIL-C has the second highest level of the safety standard, ASIL-B has the third highest level of the safety standard, and ASIL-A has the lowest level of the safety standard. The vehicle system 1 controls, in each control system D, each device E that implements a function in which ASIL is determined, and the vehicle system 1 will be described in detail below.

The vehicle system 1 includes a telematics control unit (TCU) 10 serving as a communication controller, a central gateway 20 serving as a signal distribution unit, the plurality of devices E, and an ASIL-A ECU 31, an ASIL-B ECU 32, an ASIL-C ECU 33, an ASIL-D ECU 34, an ASIL-A+α ECU 35, and a multi-level ECU 36 serving as respective controllers.

The TCU 10 is a wireless communication device capable of communicating with an external device provided outside the vehicle V. The TCU 10 wirelessly connects the vehicle V to an external device of the vehicle V via an antenna, and transmits and receives a signal between the vehicle V and the external device of the vehicle V. The TCU 10 wirelessly communicates with the external device by various types of wireless communication such as wide-area wireless communication and narrow-area wireless communication. The TCU 10 is connected to the central gateway 20, and outputs a signal received from the external device to the central gateway 20. In addition, the TCU 10 transmits a signal output from the central gateway 20 to the external device.

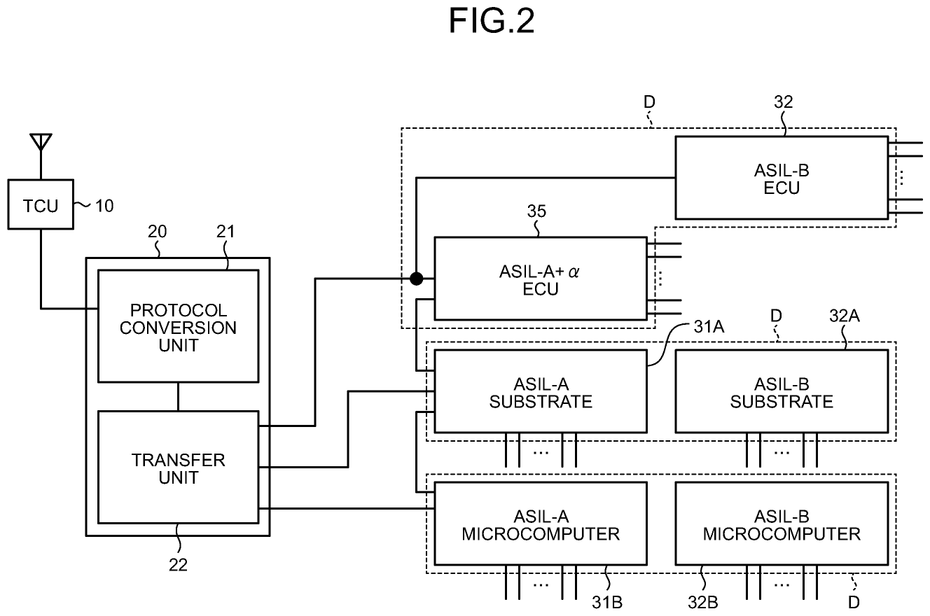

The central gateway 20 converts a protocol of a signal and transfers the converted signal. As illustrated in FIG. 2, the central gateway 20 includes a protocol conversion unit 21 and a transfer unit 22.

The protocol conversion unit 21 converts a communication protocol, and is connected to the TCU 10 and the transfer unit 22. For example, the protocol conversion unit 21 converts an Ethernet (registered trademark) protocol into a controller area network (CAN) protocol, and converts a CAN protocol into an Ethernet (registered trademark) protocol. The protocol conversion unit 21 converts, for example, an Ethernet (registered trademark) signal output from the TCU 10 into a CAN signal, and outputs the converted CAN signal to the transfer unit 22. In addition, the protocol conversion unit 21 converts a CAN signal output from the transfer unit 22 into an Ethernet (registered trademark) signal, and outputs the converted Ethernet (registered trademark) signal to the TCU 10. It is noted that the protocol conversion unit 21 may convert an Ethernet (registered trademark) protocol into a CAN with flexible data rate (CAN-FD) protocol.

The transfer unit 22 transfers a signal, and is connected to the protocol conversion unit 21 and the ECU (for example, the ASIL-B ECU 32 or the like) of each control system D. The transfer unit 22 transfers (distributes) the CAN signal output from the protocol conversion unit 21 to the ECU (for example, the ASIL-B ECU 32 or the like) of each control system D. In addition, the transfer unit 22 outputs the CAN signal output from the ECU (for example, the ASIL-B ECU 32 or the like) of each control system D to the protocol conversion unit 21. In addition, the transfer unit 22 transfers a signal between the ECUs 31 to 36, and communication between the ECUs 31 to 36 can be performed via the transfer unit 22. It is noted that the ECUs 31 to 36 are directly connected to each other without going through the transfer unit 22, and communication between the ECUs 31 to 36 can be directly performed with each other, thereby making it possible to secure redundancy.

The plurality of devices E execute various types of processing of controlling the vehicle V, and are respectively provided in the control systems D1 to D5. The plurality of devices E include the devices E that implement functions in which levels of safety standards (ASIL-A to ASIL-D) are set, and the device E that implements a function in which the levels of the safety standards (ASIL-A to ASIL-D) are not set.

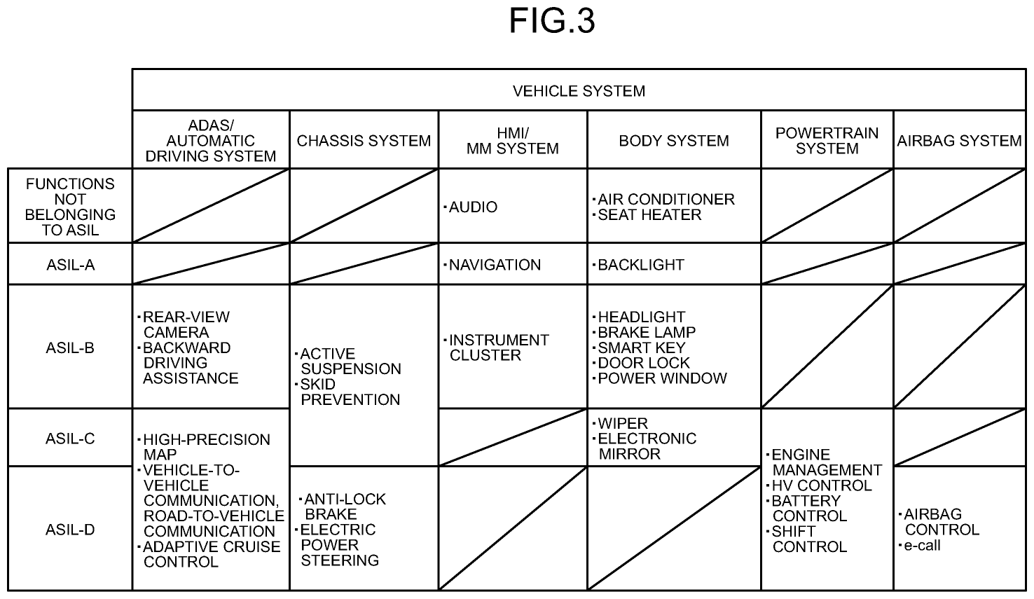

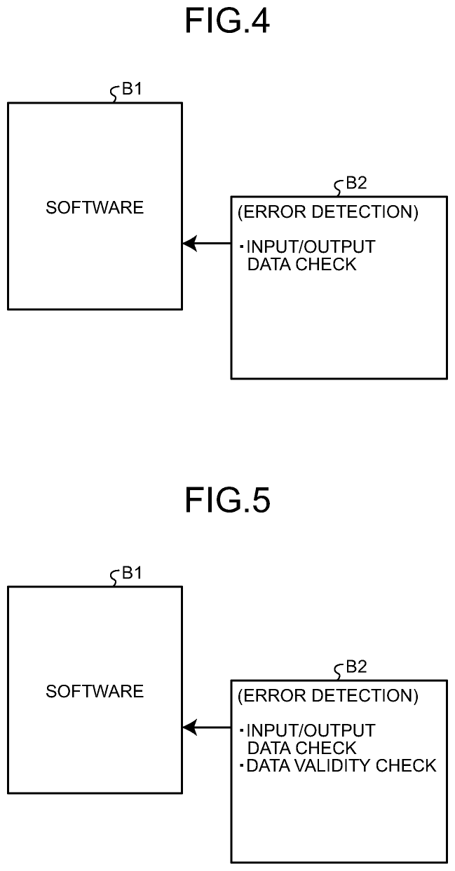

The ASIL-A ECU 31 is an integrated ECU that includes processing related to a safety standard for the device E, executes appropriate control, and integrates individual ECUs. The ASIL-A ECU 31 includes an electronic circuit mainly including a known microcomputer including a CPU, a ROM and a RAM constituting a storage unit, and an interface. The ASIL-A ECU 31 executes processing related to a safety standard on the device E that implements a function in which ASIL-A, among the ASILs, having the lowest level of the safety standard is determined. The ASIL-A ECU 31 is connected to, via an electric wire, the device E that implements a function in which a safety standard of an allocated level (ASIL-A) is set, and is not connected to the devices E that implement functions in which safety standards of different levels (ASIL-B, ASIL-C, and ASIL-D) are set. The functions in which ASIL-A is set include, for example, a navigation function, a function of turning on a backlight, and the like, as illustrated in FIG. 3. For example, the ASIL-A ECU 31 is connected to the device E that implements the navigation function and the function of turning on the backlight, and is not connected to the device E that implements a function in which the safety standard of a level different from the navigation function and the function of turning on the backlight is set. The ASIL-A ECU 31 executes, on the connected device E, processing related to a safety standard according to an allocated safety standard level (ASIL-A). For example, as illustrated in FIG. 4, the ASIL-A ECU 31 executes error detection B2 including an input/output data check as the processing related to the safety standard according to ASIL-A. The ASIL-A ECU 31 executes the error detection B2 on software B1 that executes normal processing (for example, navigation processing and backlight lighting processing) to check the input/output data. When the input/output data is abnormal, the ASIL-A ECU 31 may output information indicating that the input/output data is abnormal to an external ECU (not illustrated) or the like.

The ASIL-B ECU 32 is an integrated ECU that includes processing related to a safety standard for the device E, executes appropriate control, and integrates individual ECUs. The ASIL-B ECU 32 includes an electronic circuit mainly including a known microcomputer including a CPU, a ROM and a RAM constituting a storage unit, and an interface. In general, the ASIL-B ECU 32 has higher performance (higher number of clocks in the CPU) than that of the ASIL-A ECU 31. The ASIL-B ECU 32 executes processing related to a safety standard on the device E that implements a function in which ASIL-B, among the ASILs, having the third highest level of the safety standard is determined. The ASIL-B ECU 32 is connected to, via an electric wire, the device E that implements a function in which a safety standard of an allocated level (ASIL-B) is set, and is not connected to the devices E that implement functions in which safety standards of different levels (ASIL-A, ASIL-C, and ASIL-D) are set. The functions in which ASIL-B is set include, for example, a rear-view camera function, a function of assisting backward driving, and the like, as illustrated in FIG. 3. For example, the ASIL-B ECU 32 is connected to the device E that implements the rear-view camera function and the function of assisting backward driving, and is not connected to the device E that implements a function in which the safety standard of a level different from the rear-view camera function and the function of assisting backward driving is set. The ASIL-B ECU 32 executes, on the connected device E, processing related to a safety standard according to an allocated safety standard level (ASIL-B). For example, as illustrated in FIG. 5, the ASIL-B ECU 32 executes error detection B2 including an input/output data check and a data validity check as the processing related to the safety standard according to ASIL-B. The ASIL-B ECU 32 executes the error detection B2 on the software B1 that executes normal processing (for example, the rear-view camera function and the function of assisting backward driving) to confirm the input/output data check and the data validity check. When the input/output data is abnormal or the data is invalid, the ASIL-B ECU 32 may output information indicating that the input/output data is abnormal or the data is invalid to an external ECU or the like.

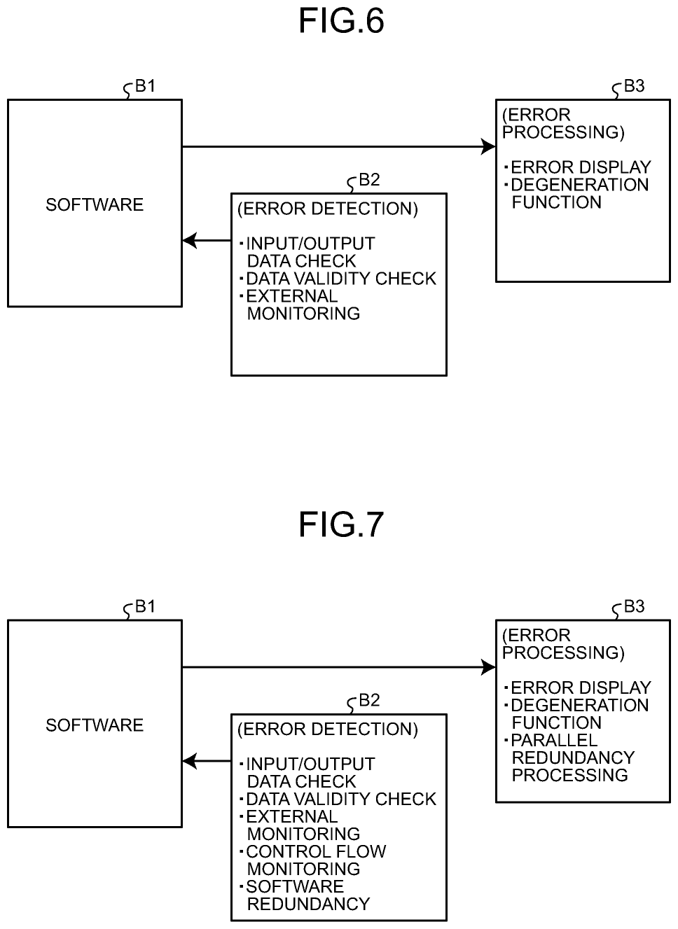

The ASIL-C ECU 33 is an integrated ECU that includes processing related to a safety standard for the device E, executes appropriate control, and integrates individual ECUs. The ASIL-C ECU 33 includes an electronic circuit mainly including a known microcomputer including a CPU, a ROM and a RAM constituting a storage unit, and an interface. In general, the ASIL-C ECU 33 has higher performance (higher number of clocks in the CPU) than that of the ASIL-B ECU 32. The ASIL-C ECU 33 executes processing related to a safety standard on the device E that implements a function in which ASIL-C, among the ASILs, having the second highest level of the safety standard is determined. The ASIL-C ECU 33 is connected to, via an electric wire, the device E that implements a function in which a safety standard of an allocated level (ASIL-C) is set, and is not connected to the devices E that implement functions in which safety standards of different levels (ASIL-A, ASIL-B, and ASIL-D) are set. The functions in which ASIL-C is set include, for example, a vehicle-to-vehicle communication function, a road-to-vehicle communication function, and the like, as illustrated in FIG. 3. For example, the ASIL-C ECU 33 is connected to the device E that implements the vehicle-to-vehicle communication function and the road-to-vehicle communication function, and is not connected to the device E that implements a function in which the safety standard of a level different from the vehicle-to-vehicle communication function and the road-to-vehicle communication function is set. The ASIL-C ECU 33 executes, on the connected device E, processing related to a safety standard according to an allocated safety standard level (ASIL-C). For example, as illustrated in FIG. 6, the ASIL-C ECU 33 executes, as the processing related to the safety standard according to ASIL-C, error detection B2 including an input/output data check, a data validity check, and an external monitoring, and further executes error processing B3 including an error display and a degeneration function. When the ASIL-C ECU 33 detects an error by executing the error detection B2 on software B1 that executes normal processing (for example, the vehicle-to-vehicle communication function and the road-to-vehicle communication function) to confirm the input/output data check, the data validity check, and the external monitoring check, the ASIL-C ECU 33 executes the error processing B3 to execute the error display and the degeneration operation.

The ASIL-D ECU 34 is an integrated ECU that includes processing related to a safety standard for the device E, executes appropriate control, and integrates individual ECUs. The ASIL-D ECU 34 includes an electronic circuit mainly including a known microcomputer including a CPU, a ROM and a RAM constituting a storage unit, and an interface. In general, the ASIL-D ECU 34 has higher performance (higher number of clocks in the CPU) than that of the ASIL-C ECU 33. The ASIL-D ECU 34 executes processing related to a safety standard on the device E that implements a function in which ASIL-D, among the ASILs, having the highest level of the safety standard is determined. The ASIL-D ECU 34 is connected to, via an electric wire, the device E that implements a function in which a safety standard of an allocated level (ASIL-D) is set, and is not connected to the device E that implements functions in which safety standards of different levels (ASIL-A, ASIL-B, and ASIL-C) are set. The functions in which ASIL-D is set include, for example, an anti-lock brake function, an electric power steering function, and the like, as illustrated in FIG. 3. The ASIL-D ECU 34 is connected to, for example, the device E that implements the anti-lock brake function and the electric power steering function, and is not connected to the device E that implements a function in which the safety standard of a level different from the anti-lock brake function and the electric power steering function is set. The ASIL-D ECU 34 executes, on the connected device E, processing related to a safety standard according to an allocated safety standard level (ASIL-D). For example, as illustrated in FIG. 7, the ASIL-D ECU 34 executes, as the processing related to the safety standard according to ASIL-D, error detection B2 including an input/output data check, a data validity check, an external monitoring, a control flow monitoring, and a software redundancy, and further executes error processing B3 including an error display, a degeneration function, and parallel redundancy processing. When the ASIL-D ECU 34 detects an error by executing the error detection B2 on software B1 that executes normal processing (for example, the anti-lock brake function and the electric power steering function) to confirm the input/output data check, the data validity check, the external monitoring check, the control flow monitoring check, and the software redundancy check, the ASIL-D ECU 34 executes the error processing B3 to execute the error display, the degeneration operation, and the parallel redundancy processing.

The ASIL-A+α ECU 35 is an integrated ECU that includes processing related to a safety standard for the device E, executes appropriate control, and integrates individual ECUs. The ASIL-A+α ECU 35 includes an electronic circuit mainly including a known microcomputer including a CPU, a ROM and a RAM constituting a storage unit, and an interface. The ASIL-A+α ECU 35 executes processing related to a safety standard on the device E that implements a function in which ASIL-A, among the ASILs, having the lowest level of the safety standard is determined, and also executes processing on the device E that implements a function in which ASIL is not determined. The ASIL-A+α ECU 35 is connected to, via an electric wire, the device E that implements a function in which a safety standard of an allocated level (ASIL-A) is set and the device E that implements a function in which ASIL-A is not determined. The ASIL-A+α ECU 35 executes, on the connected device E of ASIL-A, processing related to a safety standard according to a safety standard of an allocated level (ASIL-A), and does not execute the processing related to the safety standard on the device E that implements a function in which ASIL is not determined. For example, as illustrated in FIG. 4, the ASIL-A+α ECU 35 executes the error detection B2 including the input/output data check as the processing related to the safety standard according to ASIL-A. The ASIL-A+α ECU 35 executes the error detection B2 on the software B1 that executes normal processing (for example, the navigation processing and the backlight lighting processing) to check the input/output data. When the input/output data is abnormal, the ASIL-A+α ECU 35 may output information indicating that the input/output data is abnormal to an external ECU (not illustrated) or the like.

The multi-level ECU 36 includes processing related to a safety standard for the device E, executes appropriate control, and includes an electronic circuit mainly including a known microcomputer including a CPU, a ROM and a RAM constituting a storage unit, and an interface. The multi-level ECU 36 executes processing related to a safety standard on the device E that implements functions in which safety standards of different levels are determined. The multi-level ECU 36 is connected to, via an electric wire, each of the devices E that implement functions in which safety standards (ASIL-A, ASIL-B, ASIL-C, and ASIL-D) of different levels are set. For example, the multi-level ECU 36 is connected to, via an electric wire, each of the devices E that implement functions in which safety standards of two different levels (for example, ASIL-A and ASIL-B), safety standards of three different levels (for example, ASIL-A, ASIL-B, and ASIL-C), and safety standards of four different levels (for example, ASIL-A, ASIL-B, ASIL-C, and ASIL-D) are set. The multi-level ECU 36 executes processing related to safety standards according to different levels (ASIL-A, ASIL-B, ASIL-C, and ASIL-D).

Next, a description will be given as to the plurality of ECUs 31 to 34 respectively included in the control systems D1 to D5. Each of the control systems D1 to D5 of the vehicle V includes at least one of the ASIL-A ECU 31, the ASIL-B ECU 32, the ASIL-C ECU 33, and the ASIL-D ECU 34 according to a level of a safety standard (ASIL) of a function to be implemented by each of the devices E included in each of the control systems D1 to D5. For example, as illustrated in FIG. 1, the control system D1 representing a power train system includes the ASIL-C ECU 33 and the ASIL-D ECU 34 according to the levels of the safety standards (ASIL-C and ASIL-D) of the functions to be respectively implemented by the devices E included in the control system D1. The control system D2 representing an ADAS/automatic driving system includes the ASIL-C ECU 33 and the ASIL-D ECU 34 according to the levels of the safety standards (ASIL-C and ASIL-D) of the functions to be respectively implemented by the devices E included in the control system D2. The control system D3 representing a chassis system includes the ASIL-C ECU 33 and the ASIL-D ECU 34 according to the levels of the safety standards (ASIL-C and ASIL-D) of the functions to be respectively implemented by the devices E included in the control system D3. The control system D4 representing an HMI/MM includes the ASIL-A ECU 31 and the ASIL-B ECU 32 according to the levels of the safety standards (ASIL-A and ASIL-B) of the functions to be respectively implemented by the devices E included in the control system D4. The control system D5 representing a body system includes the ASIL-A ECU 31 and the ASIL-B ECU 32 according to the levels of the safety standards (ASIL-A and ASIL-B) of the functions to be respectively implemented by the devices E included in the control system D5. Then, in each of the control systems D1 to D5, each of the ECUs 31 to 34 is connected to a corresponding one of the devices E that implement functions in which safety standards of allocated levels are set without being connected to the device E that implements a function in which the safety standard of a different level is set, and each of the ECUs 31 to 34 executes, on the connected device E, processing (the error detection B2, the error processing B3) related to the safety standard according to the allocated level. It is noted that the configuration of the vehicle system 1 illustrated in FIG. 1 illustrates a part of the configuration of the vehicle system 1 illustrated in FIG. 3.

Next, a configuration of processing related to each safety standard will be described. Processing related to a safety standard having a relatively high level includes at least a part of processing related to a safety standard having a relatively low level. For example, as illustrated in FIGS. 4 to 7, the processing (the error detection B2 and the error processing B3) related to the safety standard (ASIL-D) having the highest level includes all types of processing (the error detection B2 and the error processing B3) related to the safety standards (ASIL-A, ASIL-B, and ASIL-C) having a relatively low level.

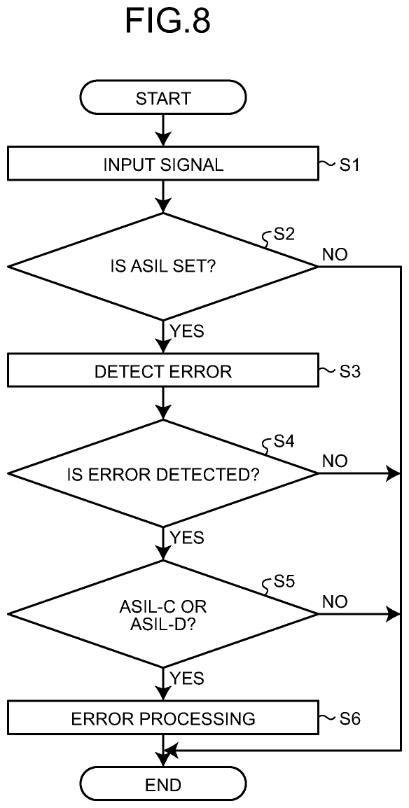

Next, an operation example of the vehicle system 1 will be described. FIG. 8 is a flowchart illustrating an operation example of the vehicle system 1. In the vehicle system 1, each of the ECUs 31 to 36 inputs a signal output from each of the devices E (Step S1). Next, each of the ECUs 31 to 36 determines whether data indicating a safety standard (ASIL) is set in the signal input from the device E (Step S2). When the data indicating the safety standard (ASIL) is set in the signal input from the device E (Step S2; Yes), each of the ECUs 31 to 36 executes error detection B2 (Step S3). Each of the ECUs 31 to 36 executes, for example, the error detection B2 on software B1 that executes normal processing, and executes an input/output data check and the like. Next, each of the ECUs 31 to 36 determines whether an error has been detected (Step S4). When the ASIL-A ECU 31 and the ASIL-B ECU 32 detect an error (Step S4; Yes), the processing ends because the level of the safety standard is not ASIL-C or ASIL-D (Step S5; No). On the other hand, when the ASIL-C ECU 33 and the ASIL-D ECU 34 detect an error (Step S4; Yes), error processing B3 is executed because the level of the safety standard is ASIL-C or ASIL-D (Step S5; Yes). For example, the ASIL-C ECU 33 executes an error display and a degeneration operation as the error processing B3 (Step S6). It is noted that, in Step S2 described above, when the data indicating the safety standard (ASIL) is not set in the signal input from the device E (Step S2; No), each of the ECUs 31 to 36 ends the processing. In Step S4 described above, when each of the ECUs 31 to 36 does not detect an error (Step S4; No), each of the ECUs 31 to 36 ends the processing.

As described above, the vehicle system 1 according to the embodiment includes the plurality of devices E and the controller. The plurality of devices E are mounted on the vehicle V, and each of the devices E implements a corresponding one of the functions in which safety standards of predetermined levels are respectively set. The controller is capable of executing processing related to the safety standard on the device E, and includes the plurality of ECUs 31 to 34 allocated for the respective levels of the safety standards. Each of the plurality of ECUs 31 to 34 is connected to a corresponding one of the devices E that implement functions in which safety standards of allocated levels are set without being connected to the device E that implements a function in which the safety standard of a different level is set, and each of the plurality of ECUs 31 to 34 executes, on the connected device E, processing related to the safety standard according to the allocated level.

According to this configuration, in the vehicle system 1, since each of the plurality of ECUs 31 to 34 executes the processing related to the safety standard according to the allocated level, it is not necessary to execute various types of processing related to the safety standards of the plurality of levels, and as such it is not necessary to match performance of the plurality of ECUs 31 to 34 with processing of a safety standard having a high level as in the related art, thereby making it is possible to avoid providing excessive performance to the plurality of ECUs 31 to 34. As a result, the vehicle system 1 can reduce the number of man-hours required for system construction, and can suppress manufacturing costs. As a result, the vehicle system 1 can appropriately construct a system that secures safety.

In the vehicle system 1, the devices E and the plurality of ECUs 31 to 34 are divided into a plurality of control systems D according to a domain. Each control system D includes at least one of the ECUs 31 to 34. According to this configuration, in the vehicle system 1, in each of the control systems D1 to D5, a plurality of ECUs can be integrated for each of the control systems D1 to D5, and the integrated ECU corresponding to each level of the safety standard can be provided, thereby making it possible to appropriately construct a system that secures safety.

The vehicle system 1 further includes the TCU 10 and the central gateway 20. The TCU 10 can communicate with an external device provided outside the vehicle V. The central gateway 20 distributes a signal received from the TCU 10 to the plurality of ECUs 31 to 34, and outputs, to the TCU 10, signals output from the plurality of ECUs 31 to 34. According to this configuration, the vehicle system 1 can be provided with the TCU 10 independently of the safety standard.

In the vehicle system 1, the processing related to the safety standard having a relatively high level includes at least a part of the processing related to the safety standard having a relatively low level. According to this configuration, the vehicle system 1 can partially share the processing related to the safety standard, and the number of man-hours can be reduced. In addition, even if processing related to a safety standard is partially shared, the vehicle system 1 executes processing related to a safety standard according to a level of individual safety standards and does not execute processing related to a safety standard according to a level of a different safety standard, thereby making it possible to prevent a problem that has occurred in processing having a low safety standard from affecting processing having a high safety standard. As a result, the vehicle system 1 can appropriately construct a system that secures safety.

The vehicle system 1 includes the multi-level controller 36 connected to the devices E that implement functions in which safety standards of different levels are set, and configured to execute, on the connected devices E, processing related to the safety standards according to the different levels. According to this configuration, the vehicle system 1 can adapt to various system aspects.

Modification

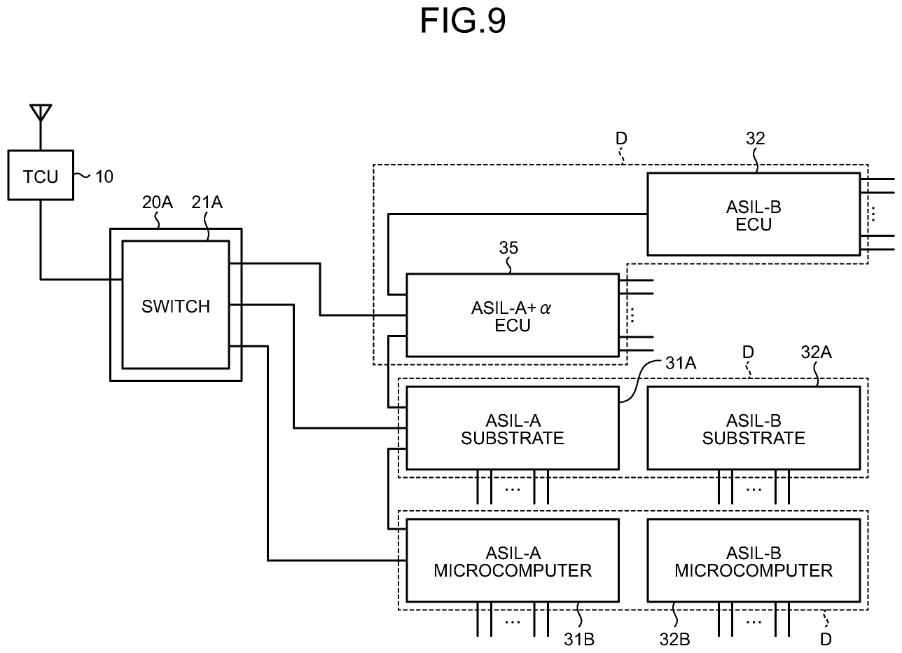

Next, a modification of the embodiment will be described. It is noted that, in the modification, component elements equivalent to those in the embodiment are denoted by the same reference numerals, and a detailed description thereof will be omitted. FIG. 9 is a block diagram illustrating a configuration example of a vehicle system 1 according to a modification. The vehicle system 1 according to the modification is different from the vehicle system 1 according to the embodiment in that a switching hub 20A is provided instead of the central gateway 20.

The switching hub 20A transfers a signal and includes a switch 21A. The switch 21A is connected to the TCU 10 and the ECU (for example, the ASIL-A+α ECU 35 or the like) of each control system D. The switch 21A transfers (distributes) an Ethernet (registered trademark) signal output from the TCU 10 to the ECU (for example, the ASIL-B ECU 32 or the like) of each control system D. The switch 21A outputs, to the TCU 10, the Ethernet (registered trademark) signal output from the ECU (for example, the ASIL-B ECU 32 or the like) of each control system D. In addition, the switch 21A transfers a signal between the ECUs 31 to 36, and communication can be performed between the ECUs 31 to 36 via the switch 21A. As described above, the vehicle system 1 according to the modification includes the switching hub 20A instead of the central gateway 20.

Although a description has been given as to an example in which the plurality of control systems D are divided into five control systems D1 to D5, but the present invention is not limited thereto, and the plurality of control systems D may be divided into other numbers of systems.

Although ASIL defined in the ISO 26262 standards has been described as a safety standard, the safety standard is not limited thereto and may be other standards.

As illustrated in FIG. 2, each of the ECUs 31 to 36 may be provided for each ECU, for each substrate (for example, an ASIL-A substrate 31A and an ASIL-B substrate 32A), or for each microcomputer (an ASIL-A microcomputer 31B and an ASIL-B microcomputer 32B).

Although a description has been given as to an example in which the devices E and the plurality of ECUs 31 to 34 are divided into the plurality of control systems D according to the domain, and each control system D includes at least one of the ECUs 31 to 34, the present invention is not limited thereto. For example, the devices E and the plurality of ECUs 31 to 34 may be divided into the plurality of control systems D according to an area indicating a certain range in the vehicle V, and each control system D may include at least one of the ECUs 31 to 34.

Although a description has been given as to an example in which the vehicle system 1 further includes the TCU 10 and the central gateway 20, the present invention is not limited thereto, and the vehicle system 1 may not include the TCU 10 and the central gateway 20.

A description has been given as to an example in which the processing related to the safety standard having a relatively high level includes at least a part of the processing related to the safety standard having a relatively low level, but the present invention is not limited thereto, and the processing related to the safety standard may be configured by another method.

Although a description has been given as to an example in which the vehicle system 1 includes the multi-level controller 36, the present invention is not limited thereto, and the vehicle system 1 may not include the multi-level controller 36.

A vehicle system according to the present embodiment does not need to execute processing related to safety standards of a plurality of levels, and as such it is not necessary to match performance of a plurality of single-level controllers with processing of a safety standard having a high level as in the related art, thereby making it possible to avoid providing excessive performance to the plurality of single-level controller. As a result, it is possible to appropriately construct a system that secures safety.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle system comprising:
a plurality of devices mounted on a vehicle, each of the devices implementing a function having a safety standard of a predetermined level set therein; and
a controller configured to execute, on the devices, processing related to the safety standard,
wherein the controller includes a plurality of single-level controllers, each of the single-level controllers being allocated for a corresponding one of the levels of the safety standards, and
wherein each of the single-level controllers is connected to a corresponding one of the devices configured to respectively implement the functions in which the safety standards of the allocated levels are set without being connected to the device configured to implement the function in which the safety standard of a different level is set, and executes, on the corresponding device connected thereto, processing related to the safety standard according to the allocated level without processing related to the safety standard of a plurality of levels.

2. The vehicle system according to claim 1, wherein
the devices and the controller are divided into a plurality of control systems according to a domain, and
each of the control systems includes at least one of the single-level controllers.

3. The vehicle system according to claim 1, further comprising:
a communication controller configured to communicate with an external device provided outside the vehicle; and
a signal distribution unit configured to distribute a signal received from the communication controller to the plurality of single-level controllers, and to output signals output from the plurality of single-level controllers to the communication controller.

4. The vehicle system according to claim 2, further comprising:
a communication controller configured to communicate with an external device provided outside the vehicle; and
a signal distribution unit configured to distribute a signal received from the communication controller to the plurality of single-level controllers, and to output signals output from the plurality of single-level controllers to the communication controller.

5. The vehicle system according to claim 1, wherein processing related to the safety standard having the relatively high level includes at least a part of processing related to the safety standard having the relatively low level.

6. The vehicle system according to claim 2, wherein processing related to the safety standard having the relatively high level includes at least a part of processing related to the safety standard having the relatively low level.

7. The vehicle system according to claim 3, wherein processing related to the safety standard having the relatively high level includes at least a part of processing related to the safety standard having the relatively low level.

8. The vehicle system according to claim 1, wherein the controller includes a multi-level controller connected to the device configured to implement the function in which the safety standard of the different level is set, and executes, on the device connected thereto, processing related to the safety standard according to the different level.

9. The vehicle system according to claim 2, wherein the controller includes a multi-level controller connected to the device configured to implement the function in which the safety standard of the different level is set, and executes, on the device connected thereto, processing related to the safety standard according to the different level.

10. The vehicle system according to claim 3, wherein the controller includes a multi-level controller connected to the device configured to implement the function in which the safety standard of the different level is set, and executes, on the device connected thereto, processing related to the safety standard according to the different level.

11. The vehicle system according to claim 5, wherein the controller includes a multi-level controller connected to the device configured to implement the function in which the safety standard of the different level is set, and executes, on the device connected thereto, processing related to the safety standard according to the different level.
